(19) United States
(12) Patent Application Publication
(10) Pub. No.: US 2013/0029800 A1
(43) Pub. Date: Jan. 31, 2013

(54) ASSEMBLY OF COMBUSTION ENGINE AND PLANETARY GEAR TRAIN CONNECTED TO THE COMBUSTION ENGINE

(71) Applicant: Stefan Langbein, Geisenfeld (DE)

(72) Inventor: Stefan Langbein, Geisenfeld (DE)

(73) Assignee: Audi AG, Ingolstadt (DE)

(21) Appl. No.: 13/362,967

(22) Filed: Jan. 31, 2012

(30) Foreign Application Priority Data
Feb. 1, 2011 (DE) DE 102011010087.3

(51) Int. Cl. F16H 37/02; F16H 57/08

(52) U.S. Cl. 475/343; 475/347

(57) ABSTRACT

A combustion engine having at least one combustion chamber and a crankshaft is combined with a planetary gear train having a ring gear, a sun gear, and a plurality of planetary gears rotatably mounted on a planet carrier and interacting with the ring gear and the sun gear. In order to dampen or absorb vibrations of the crankshaft of the combustion engine, a vibration damper unit is provided to keep the vibrations away from the planetary gear train. The vibration damper unit includes a support member which is attached to the crankshaft at a location which is in closer proximity of the combustion chambers of the combustion engine than a connection member by which the crankshaft is coupled to the planetary gear train.

### CROSS-REFERENCES TO RELATED APPLICATIONS

This application claims the priority of German Patent Application, Serial No. 10 2011 010 087.3, filed Feb. 1, 2011, pursuant to 35 U.S.C. 119(a)-(d), the content of which is incorporated herein by reference in its entirety as if fully set forth herein.

### BACKGROUND OF THE INVENTION

The present invention relates to an assembly of a combustion engine and a planetary gear train which is coupled to the combustion engine in a defined manner.

The following discussion of related art is provided to assist the reader in understanding the advantages of the invention, and is not to be construed as an admission that this related art is prior art to this invention.

Typically, a combustion engine is coupled with an electric machine via a planetary gear train and optionally a further transmission, such as e.g. a belt drive. The electric machine operates hereby as starter for the combustion engine and can be operated as a generator at the same time. The planetary gear train is attached by connecting a sun gear, planet carrier or ring gear to a crankshaft of the combustion engine via a connection member, normally a flange that is mounted to the crankshaft at an end which is distal to a combustion chamber of the combustion engine.

It would be desirable and advantageous to address prior art shortcomings and to realize an optimum force flow between the crankshaft and the planet carrier while enhancing a dampening or absorption of vibrations of the crankshaft without adversely affecting the overall performance of the assembly.

### SUMMARY OF THE INVENTION

According to one aspect of the present invention, a combustion engine having at least one combustion chamber and a crankshaft is combined with a planetary gear train having a ring gear, a sun gear, a plurality of planetary gears rotatably mounted on a planet carrier and interacting with the ring gear and the sun gear, a connection member connecting an element selected from the group consisting of sun gear, planet carrier, and ring gear, to the crankshaft, and a support member having a vibration damper and connected to the crankshaft at an attachment zone which is arranged closer to the at least one combustion engine than the connection member.

The present invention resolves prior art shortcomings by placing the attachment zone of the support member, which carries the vibration damper (or a vibration absorber), to the crankshaft in closer proximity to the combustion chamber of the combustion engine than the attachment zone via which the planet carrier with its connection member is connected to the crankshaft. In other words, the planet carrier is connected closer to the end of the crankshaft than the support member. By connecting the support member to the crankshaft at a different location as the connection member, a torque is able to migrate via a first path of action to the vibration damper or vibration absorber to thereby bypass the planetary gear train, whereas the torque from the crankshaft to the planet carrier is transmitted via a second path of action.

In accordance with the present invention, the assembly comprised of combustion engine and planetary gear train is configured in such a way that a first torque can be introduced into the damping unit via a first path of action, and a separate second path of action is established via which a torque can be introduced into the planetary gear train which is connected to the crankshaft. The ratio between the torque transmitted via the first path of action and the torque transmitted via the second path of action depends on the frequency of the rotation. Interfering vibrations of the crankshaft, as encountered as a result of excitation by a plurality of combustion chambers connected thereto, are predominantly transmitted via the support member to the vibration damper and/or vibration absorber, while a drive torque is transmitted with the number of revolutions of the crankshaft predominantly onto the planetary gear train.

According to another advantageous feature of the present invention, the support member can include a sheet metal body and a metallic ring which is attached to the metal sheet and operates as vibration damper. Advantageously, the metallic ring is connected to the sheet metal body via an elastic member, e.g. a rubber ring. A sheet metal body of this type can be easily produced and connected to the crankshaft.

According to another advantageous feature of the present invention, the crankshaft can be connected to the planet carrier, and a pulley can be connected to the sun gear, with the metal ring being arranged between a portion of the ring gear and a radially outer portion of the pulley. In this way, the pulley is able to seal at least in part the assembly of combustion engine and planetary gear train to the outside.

According to another advantageous feature of the present invention, an electromagnetic mechanism including an electromagnet and an armature can be provided, with the armature interacting with the electromagnet and coupled to the ring gear, wherein the electromagnet and the armature are placed at an axial offset in relation to the metallic ring. The axial offset is hereby related to a rotation axis of the elements of the planetary gear train, i.e. sun gear, planet carrier, and ring gear. In this way, the ring gear is mounted to a fixed component of the combustion engine to provide particular operating modes and a compact construction of the assembly is realized. The metallic ring and the armature with the electromagnet are compact enough to allow their disposition axially behind one another without significantly increasing the overall axial depth of the assembly.

According to another advantageous feature of the present invention, the sun gear and the planet carrier can be coupled to one another by a freewheel. In this way, the sun gear in particular is able to move past the planet carrier, i.e. rotate at a rotation speed which is greater than a rotation speed of the planet carrier. As a result, those components which are connected via the pulley can be operated at correspondingly high rotation speed independently from the combustion engine. The function of the freewheel can also be assumed by a controllable clutch which in addition enables further functions of the planetary gear train.

This applies in particular for an electric machine which e.g. can operate as starter for the combustion engine and at the same time can be operated as generator. When used in a motor vehicle, the electric machine can advantageously be coupled to the combustion engine via a belt drive which includes the pulley.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic basic illustration of an assembly of combustion engine and planetary gear train in accordance with the present invention, with depiction of an electric machine connected via a belt drive; and

FIG. 2 is a radial section of the planetary gear train with a pulley of the belt drive and a vibration damper.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

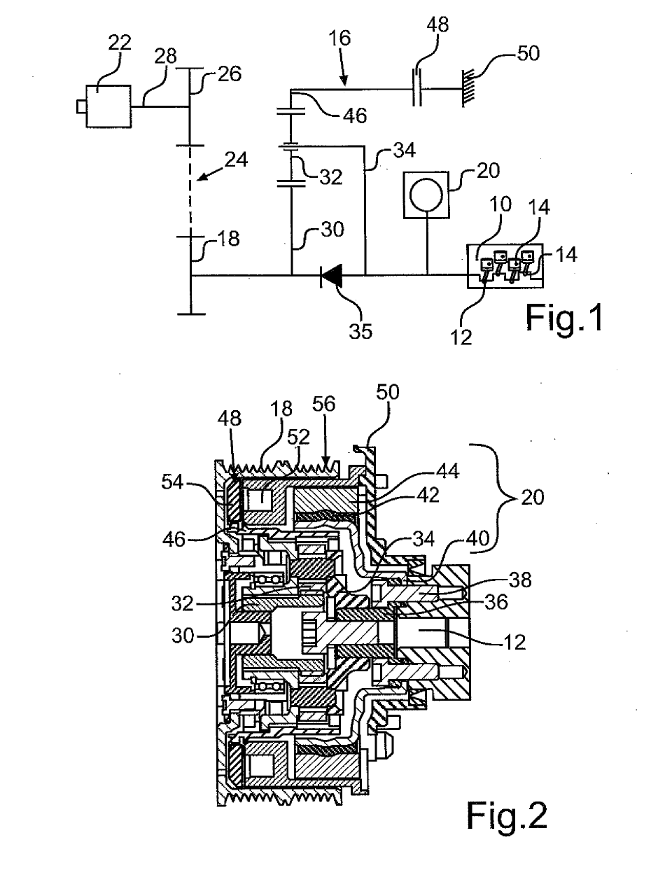

Turning now to the drawing, and in particular to FIG. 1, there is shown a schematic basic illustration of an assembly in accordance with the present invention, generally designated by reference numeral 16 and comprised of a combustion engine 10 and a planetary gear train. The combustion engine 10 includes a crankshaft 10 which is caused to rotate as a result of a movement of pistons in combustion chambers 14. The planetary gear train is coupled to the combustion engine 10 and includes a sun gear 30 which is connected to a pulley 18 for attachment of an electric machine 22 via a belt drive 24. The belt drive 24 includes a pulley 26 which rotates conjointly with a rotor (not shown) of the electric machine 22 via a shaft 28. In mesh with the sun gear 30 are planetary gears 32 which are rotatably mounted on a planet carrier 34. Placed between the planet carrier 34 and the sun gear 30 is a freewheel 35. The planet carrier 34 is connected by a flange 36 with the crankshaft 12 of the combustion engine 10. A support plate 40 is clamped between the flange 36 and the crankshaft 12. Placed upon the support plate 40 is a rubber ring 42 which in turn supports a steel ring 44. The support plate 40, the rubber ring 42, and the steel ring 44 form together a vibration damper 20.

The planetary gear train further includes a ring gear 46 which is operatively connected via a brake 48 with a fixed component 50 of the combustion engine 10. The brake 48 includes an electromagnet 52 which is mounted to the fixed component 50 of the combustion engine 10 and constructed to attract an armature 54 which is connected with the ring gear 46.

As can be seen from FIG. 2, the steel ring 44 with the rubber 42, on one hand, and the electromagnet 52 and the armature 54, on the other hand, are arranged in a same radial region precisely between a radial outer portion of the pulley 18 and the outer ring gear 46. This area of the radial region is especially suitable for installation of all these components. As further shown in FIG. 2, the radial outer portion of the pulley 18 has an outer profiling 56.

Clamping the support plate 40 between the flange 36 and the crankshaft 12 advantageously permits the implementation of a path of action from the crankshaft 12 to the steel ring 44 which completely bypasses the planetary gear train. The attachment zone of the support plate 40 to the crankshaft 12 is located in closer proximity of the pistons and the pertaining combustion chambers 14 of the combustion engine 10 than the attachment zone of the planet carrier 34 to the crankshaft 12. In the presence of so-called dynamic torques, i.e. unwanted torques caused by vibrations of the crankshaft 12, about 75% of such dynamic torques can now be introduced into the vibration damper 20 so that only 25% are transmitted into the planetary gear train. As a result, the planetary gear train of the assembly 16 is better protected against vibrations compared to convention paths of action.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An assembly, comprising:
a combustion engine having at least one combustion chamber and a crankshaft; and
a planetary gear train having a ring gear, a sun gear, a plurality of planetary gears rotatably mounted on a planet carrier and interacting with the ring gear and the sun gear, a connection member connecting an element selected from the group consisting of sun gear, planet carrier, and ring gear, to the crankshaft, and a support member having a vibration damper and connected to the crankshaft at an attachment zone which is arranged closer to the at least one combustion engine than the connection member.

2. The assembly of claim 1, wherein the support member includes a sheet metal body and a metallic ring attached to the metal sheet.

3. The assembly of claim 2, wherein the metallic ring is attached to the metal sheet via an elastic member.

4. The assembly of claim 3, wherein the elastic member is a rubber ring.

5. The assembly of claim 1, wherein the crankshaft is connected to the planet carrier, and further comprising a pulley connected to the sun gear, said metal ring being arranged between a portion of the ring gear and a radially outer portion of the pulley.

6. The assembly of claim 1, further comprising an electromagnetic mechanism including an electromagnet and an armature interacting with the electromagnet and coupled to the ring gear, wherein the electromagnet and the armature are placed at an axial offset in relation to the metallic ring.

7. The assembly of claim 1, wherein the sun gear and the planet carrier are coupled to one another by a freewheel.

8. The assembly of claim 1, wherein the sun gear and the planet carrier are coupled to one another by a clutch.

9. The assembly of claim 3, further comprising an electric machine coupled to the combustion engine by a belt drive, said pulley being part of the belt drive.
